(19) United States
(12) Patent Application Publication
(10) Pub. No.: US 2025/0150464 A1
(43) Pub. Date: May 8, 2025

(54) INFORMATION SHARING FOR CYBERATTACK RECOGNITION AND RESPONSE

(71) Applicant: Wells Fargo Bank, N.A., San Francisco, CA (US)

(72) Inventors: Edward Heuser, Charlotte, NC (US); Mary Townsend, Irving, TX (US); Jerry Reynolds, Charlotte, NC (US); Chelsea Hope Vivas Rodriguez, Toccoa, GA (US); Bassel Farra, Charlotte, NC (US); Michael Sbandi, Harrisburg, NC (US); Natassia Major, Charlotte, NC (US)

(21) Appl. No.: 18/502,480

(22) Filed: Nov. 6, 2023

(51) Int. Cl. H04L 9/40

(52) U.S. Cl. CPC H04L 63/1416

(57) ABSTRACT

This disclosure describes techniques for maintaining and using a warehouse of data about potential or actual cyberattack threats for an industry. In one example, this disclosure describes a method that includes outputting, by a computing system operated by a first entity and to a data warehouse, information about activity within a first network operated by the first entity; receiving, by the computing system and from the data warehouse, information about attributes of a peer attack directed to a second network operated by a second entity, wherein the first entity and the second entity may be marketplace competitors; applying, by the computing system, a model to identify a network asset included within the first network that is vulnerable to an attack having the attributes of the peer attack; and outputting, by the computing system and to the network asset, a control signal to modify the operation of the network asset.

### TECHNICAL FIELD

This disclosure relates to computer networking, and more specifically, to techniques for detecting and responding to cyberattacks.

### BACKGROUND

The intensifying sophistication and frequency of cyberattacks pose a significant threat to many industries, organizations, and processes, particularly those that serve as critical societal infrastructures. Timely identification and response to cyberthreats are important steps in effectively securing an organization's network infrastructure and thereby preventing damage, disruption, and loss. Organizations often respond or prepare to respond to cyberthreats by adopting a threat management process, but such processes are not always effective.

### SUMMARY

This disclosure describes techniques for maintaining and using a warehouse of data about potential or actual cyberthreats for an industry, and using the warehouse to counter or prevent cyberattacks. As described herein, information may be shared by participants within a given industry, with each participant updating the warehouse of data as new information is collected by each participant. Analytics may be applied to the data collected in the warehouse by an organization that administers and/or maintains the warehouse. Such evaluations may be shared with industry participants to provide such participants with a wider visibility into attack profiles and characteristics, and to enable such participants to prevent, counter, and/or otherwise address potential and/or ongoing attacks.

Alternatively, or in addition, data collected by the warehouse may be shared with industry participants, and analytics may be independently performed by each industry participant to analyze, prevent, counter, and/or address any potential attack or ongoing attack. In such an example, each industry participant could develop its own analytics and/or artificial intelligence solutions to identify attacks and conceive of appropriate ways to address threats relevant to their own attack surface.

In some cases, but not all, participants that contribute data to the shared warehouse of data are marketplace competitors, but may nevertheless have a shared interest in protecting their computing and network infrastructure against cyberattacks. Each participant may, prior to sharing data, appropriately process its data to ensure that the data being shared complies with privacy and regulatory standards or guidelines, and also to ensure that no competitive information is being shared with other marketplace competitors.

In some examples, this disclosure describes operations performed by a computing system in accordance with one or more aspects of this disclosure. In one specific example, this disclosure describes a method comprising outputting, by a computing system operated by a first entity and to a data warehouse, information about activity within a first network operated by the first entity; receiving, by the computing system and from the data warehouse, information about attributes of a peer attack directed to a second network operated by a second entity, wherein the first entity and the second entity are marketplace competitors; applying, by the computing system, a model to identify a network asset included within the first network that is vulnerable to an attack having the attributes of the peer attack; and outputting, by the computing system and to the network asset, a control signal to modify the operation of the network asset.

In another example, this disclosure describes a system comprising a storage system and processing circuitry having access to the storage system, wherein the processing circuitry is configured to carry out operations described herein. In yet another example, this disclosure describes a computer-readable storage medium comprising instructions that, when executed, configure processing circuitry of a computing system to carry out operations described herein.

The details of one or more examples of the disclosure are set forth in the accompanying drawings and the description herein. Other features, objects, and advantages of the disclosure will be apparent from the description and drawings, and from the claims.

### BRIEF DESCRIPTION OF THE DRAWINGS

FIG. 1A is a conceptual diagram illustrating an example system in which multiple entities contribute data to a data warehouse to enable enhanced detection and/or response to cyberattacks, in accordance with one or more aspects of the present disclosure.

FIG. 1B is a conceptual diagram illustrating a process that may be employed by a computing system for processing shared data from a data warehouse, in accordance with one or more aspects of this disclosure.

FIG. 2 is a block diagram illustrating example computing systems operating within an example system in which multiple entities contribute data to a data warehouse to enable enhanced detection and/or response to cyberattacks, in accordance with one or more aspects of the present disclosure.

FIG. 3 is a flow diagram illustrating operations performed by an example computing system in accordance with one or more aspects of the present disclosure.

### DETAILED DESCRIPTION

This disclosure seeks to address certain systemic weaknesses that limit effective detection and response to cyberattacks. Typically, within an industry, there is limited technical information sharing across similar enterprises within an industry. Shared Cyber Threat Intelligence (CTI) and Indicators of Compromise (IoC) that enterprises may exchange directly are often unreliable because the data has been significantly redacted due to the lack of trust between stakeholders, and therefore rarely includes valuable risk indicators. CTI is also often obtained outside of an actionable timeframe. CTI might only be available informally through peers, which additionally presents a data quality challenge. Further, when CTI is received, it is typically not ingested directly into tools where it would be programmatically actionable, further reducing response time. The usefulness of such data decays over time, and delayed responses to delayed data are often ineffective.

In addition, when the data indicates the presence of a threat, there is a tendency to immediately eject every threat actor to stop the threat. Although quickly ejecting threat actors helps lead to quick and effective threat resolutions, it also limits information gathering about attack characteristics and patterns, which might otherwise lead to more useful information about the attack source and more effective long term resolutions.

As described herein, these weaknesses can be addressed through intra-industry sharing of threat data. Cyberattack pattern recognition can be applied to the shared information, which represents a wider corpus of data than is available to any one member of the industry, and which can be expected to lead to more effective pattern recognition results. The results of the pattern recognition may be fed into systems operated by each industry participant, enabling automated deployment of security controls capable of preventing and/or countering attacks.

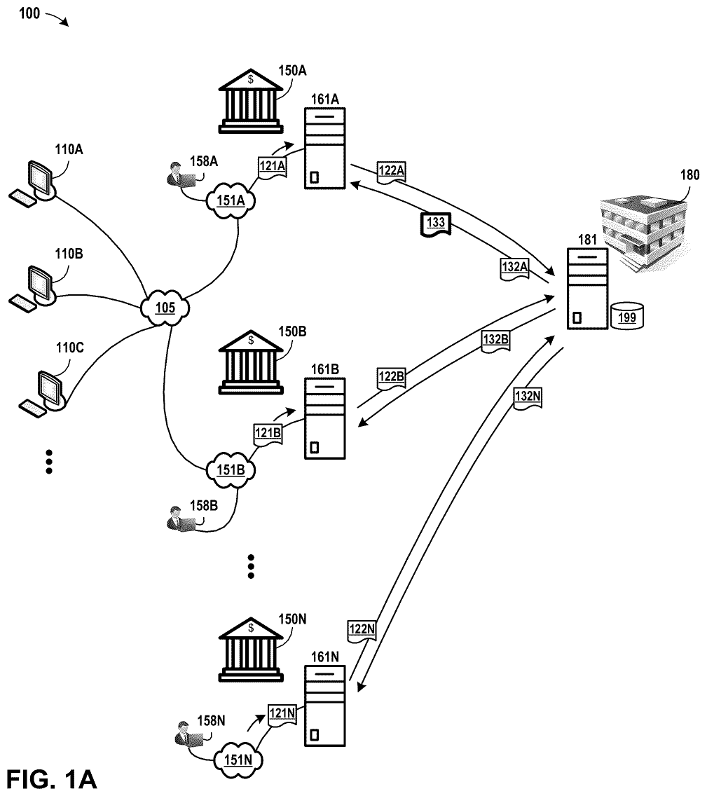

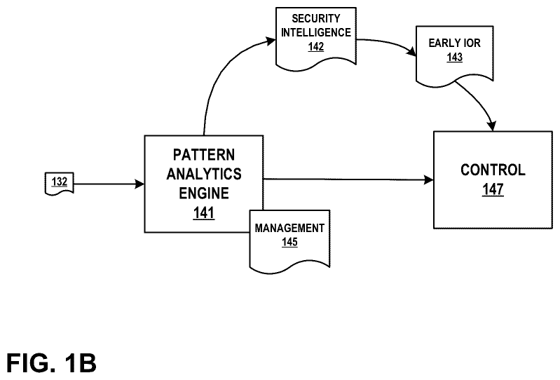

FIG. 1A is a conceptual diagram illustrating an example system in which multiple entities contribute data to a data warehouse to enable enhanced detection and/or response to cyberattacks, in accordance with one or more aspects of the present disclosure. System 100 of FIG. 1A illustrates entities 150A, 150B, through 150N (collectively “entities 150” and representing any number of entities). Each of entities 150 may be considered to be a member of a particular industry, which may be an industry that serves as a critical foundation for society. One such industry is the financial services industry, so each of entities 150 may represent a bank or other financial institution. In another example, each of entities 150 may represent a member of the healthcare industry, such that each entity represents a healthcare organization, healthcare provider, and/or a health insurer.

In FIG. 1A, each of entities 150A through 150N control and/or operate network infrastructures 151A through 151N, respectively. These network infrastructures 151A through 151N (collectively “network infrastructures 151”) represent various physical and/or virtual computing systems and network devices. Such systems and device may include, for example, computing systems 161A through 161N (collectively “computing systems 161”) and administrator computing devices 158A through 158N (collectively “administrator computing devices 158”). As shown in FIG. 1A, computing system 161A is part of network infrastructure 151A, computing system 161B is part of network infrastructure 151B, and in general, computing system 161N is part of network infrastructure 151N. Administrator computing device 158A may be operated by an administrator employed by or otherwise associated with entity 150A.

Similarly, administrator computing device 158B, which is part of network infrastructure 151B, may be operated by an administrator associated with entity 150B, and in general, administrator computing device 158N may be operated by an administrator for entity 150N.

Client devices 110A through 110C (collectively “client devices 110,” and representing any number of computing devices) may interact with entities 150 by communicating over network 105. Often, operators of client devices 110 are customers of a given entity 150. For example, where each of entities 150 is a bank or financial institution, operators of client devices 110 may be banking customers or agents of organizations that do business with a given one of entities 150. Typically, a user or customer of entity 150A may communicate with entity 150A by using a client device 110 to communicate, over network 105, with customer-facing computing systems within network infrastructure 151A operated by entity 150A. Similarly, a user may communicate with entity 150B by using a client device 110 to communicate, over network 105, with customer-facing computing systems within network infrastructure 151B operated by entity 150B.

However, in some cases, an operator of a client device 110 may represent a threat to one or more of entities 150, in that the operator is a threat actor seeking to improperly gain unauthorized access to or otherwise disrupt the operation of one or more network infrastructures 151. Accordingly, each of entities 150 may, as is conventional, take actions to protect the network infrastructures 151 they operate and/or control from various cyberthreats, cyberattacks, or other unwanted actions directed to that entity's network infrastructure 151. Attacks on network infrastructure 151 may be initiated from a number of origins, beyond the client devices 110 illustrated in FIG. 1A. However, for convenience, at least some of the attacks described herein are contemplated as being initiated from one or more client devices 110 in FIG. 1A. Techniques described herein may, however, apply to attacks initiated through other means.

As described herein, each of entities 150 may share data with organization 180. The data shared by each of entities 150 with organization 180 may pertain to normal and/or abnormal network activities, interactions, or other operations. Such data may include attack data from any other appropriate source (e.g., bug bounty programs and the like), and such data may be normalized to the shared data model. Organization 180 may receive data from each of entities 150, and analyze and/or process the data as part of an effort to detect and/or respond to cyberattacks that may be directed to any of entities 150. Such an analysis may provide insights into the data that might not otherwise be apparent to each individual entity if each entity were to consider only data available through monitoring its own infrastructure.

Although techniques described herein may apply to many types of data and business entities, each of entities 150 may, in one example, be considered a separately or independently-operated financial institution or bank. In such an example, organization 180 may be an association of multiple financial institutions or a consortium of entities 150 that seek to share some aspects of their data (particularly as it relates to their respective network infrastructure 151) to better evaluate, assess, and analyze various threats to network infrastructures 151. Alternatively, organization 180 may be organized as a joint venture or partnership of various entities (e.g., entities 150). Organization 180 could be organized as a non-profit organization. In other examples, organization 180 may be a private, for-profit independent entity that none of entities 150 directly or indirectly control. Although organization 180 may itself be one of entities 150 (i.e., in the sense that organization 180 is a bank or financial institution or otherwise in the same line of business as other entities 150), organization 180 is preferably independent of each of entities 150 to enable more effective treatment of privacy issues, competitive issues, and other issues.

Although certain techniques are described herein in the context of participants within an “industry” sharing information on an intra-industry basis (e.g., financial, healthcare, or others), such techniques may apply to other contexts as well. For example, information may be shared across a set of industries, and such inter-industry sharing could also be used to prevent or counter cyberattacks across those industries. Further, depending on the structures of various entities or organizations to which the techniques might be applied, data sharing within an organization's lines of business (or other sub-organizations) may be appropriate, including (but not limited to) federated lines of business within a larger organization (e.g., various lines of business within a bank). Accordingly, while techniques described herein may enable sharing of information across marketplace competitors within an industry, techniques described herein are not necessarily limited to contexts involving a specific industry and/or marketplace competitors. As noted above, each of entities 150 owns, operates, and/or controls various computing systems. Specifically, entity 150A owns, operates, and/or controls computing system 161A, entity 150B owns, operates, and/or controls computing system 161B, and entity 150C owns, operates, and/or controls computing system 161C. Each such computing system 161 may be used by a respective entity 150 for monitoring a respective network infrastructure 151 and sharing information about operations and activity of that network infrastructure 151 with organization 180. Although computing systems 161A, 161B, and 161C are shown as a single system, such systems are intended to represent any appropriate computing system or collection of computing systems that may be employed by each of entities 150. Such computing systems may include a distributed, cloud-based data center or any other appropriate arrangement.

Organization 180 may also own, operate, and/or control various computing systems, including computing system 181. Although computing system 181 is shown as a single system, computing system 181 is also intended to represent any appropriate computing system or collection of computing systems, and may include a distributed, cloud-based computing system, data center or any other appropriate arrangement. Computing system 181 may communicate with other computing systems in FIG. 1A over a network (e.g., a network connecting computing system 181 and computing systems 161, not specifically shown). Such a network may, in some examples, be the internet.

Generally, and for ease of illustration, only a limited number of entities 150, network infrastructures 151, administrator computing devices 158, computing systems 161, organizations 180, and computing systems 181 are shown in FIG. 1A and FIG. 1B. Techniques described herein may, however, apply to a system involving any number of entities 150 or organizations 180, where each of entities 150 and/or organizations 180 may have any number of network infrastructures 151, administrator computing devices 158, computing systems 161, and/or computing systems 181.

In operation, each of entities 150 may collect data about network operations and share the data with organization 180. For instance, in an example that can be described in the context of FIG. 1A, computing system 161A collects threat data 121A from network infrastructure 151A. Threat data 121A may include both CTI and IOC, but may also include specific details about network operations occurring within network infrastructure 151A, including information about events, alerts, incidents, logs maintained for network infrastructure 151A. Threat data 121A may also include information about traffic patterns, user authorizations, normal operations, information about customer or public-facing systems and non-public systems, and other information. Computing system 161A modifies the processed data 122A to produce processed data 122A, and outputs the processed data 122A to computing system 181.

Similarly, computing system 161B collects threat data 121B from network infrastructure 151B, modifies the data to produce processed data 122B, and outputs the processed data 122B to computing system 181. And in general, computing system 161N collects threat data 121N from network infrastructure 151N, modifies the data to produce processed data 122N, and outputs the processed data 122N to computing system 181. The modifications each of computing systems 161 make to threat data 121 may involve anonymizing and/or treating threat data 121 for privacy and other issues, and making threat data 121 suitable for sharing with organization 180.

Each of computing systems 161 may upload processed data 122 to a data warehouse 199 maintained by organization 180 through computing system 181. In some examples, processed data 122 is uploaded in near- or seemingly-near real time, which helps to ensure that the latest threat intelligence is available to computing system 181. Computing system 181 stores data from various sources formatted in machine readable format for feeding into systems used by financial institutions, regulatory agencies, and cyberthreat intelligence providers. As described, each of computing systems 161 may be responsible for using automated privacy-enhancing computation techniques, such as smart contracts via an oracle, central distro, or a standardized data anonymization mechanism (e.g., data masking or generalization) to protect sensitive data being sent to computing system 181 (and which may thereafter be distributed to other entities 150).

When uploading processed data 122, each of computing systems 161 may integrate processed data 122 with data from other systems, such as XDR (extended detect and response) or SOAR (security orchestrations, automation, and response) systems. Processed data 122 may also be prepared for machine learning consumption and standardized based upon an industry standard framework (e.g., NIST SIEM requirements and standards), including standardized asset and data classification labeling to safely provide details about the assets, devices, hosts, account types, credentials, services/daemons, ports, compromised servers, and other attributes of underlying assets and/or data. In some examples, such preparation of processed data 122 will standardize the data in a manner consistent with steps/tactics language based on the MITRE ATT&CK framework.

Computing system 181 may analyze and/or distribute processed data 122 received from each of computing systems 161. For instance, continuing with the example being described with reference to FIG. 1A, computing system 181 performs analytics on processed data 122, accessing the data through data warehouse 199. Based on its analysis, computing system 181 may generate one or more notifications 133, providing information about a detected ongoing attack threatening network infrastructures 151 associated with one or more entities 150. Alternatively, or in addition, computing system 181 may distribute shared data 132 to each of computing systems 161, enabling each of entities 150 to perform its own analytics.

Each of computing systems 161 may act on shared data 132 received from computing system 181. For instance, still referring to FIG. 1A, computing system 161A may receive notification 133 and/or shared data 132A. Computing system 161A may compare the attack identified by notification 133 against any internal inventory of assets and their associated vulnerabilities to identify assets that may require strengthening, and/or to evaluate if there is heightened risk due to incoming information (e.g., shared data 132A). If any inventoried assets are at risk, computing system 161A may notify relevant internal personnel (e.g., an operator of administrator computing device 158A).

If any assets are at risk, computing system 161A may also deploy one or more new security controls (e.g., using infrastructure as code techniques) and/or strengthen or reconfigure existing security controls. Such security controls may be any type of safeguard or countermeasure to avoid, detect, counteract, or minimize security risks to network infrastructure 151A. Security controls are sometimes classified by criteria, such as when they act relative to a security breach. In such a classification, preventive controls act before an event and are intended to prevent an incident from occurring, such as by locking out unauthorized intruders. Detective controls act during an event, and are intended to identify and characterize an incident in progress, such as by sounding the intruder alarm and alerting the security guards or police. Corrective controls act after the event, and are intended to limit the extent of any damage caused by the incident, which may include restoring the organization to normal working status as efficiently as possible.

Security controls can also be classified according to their characteristics. For instance, “physical” security controls may include fences, doors, locks, and fire extinguishers. Security controls classified as “procedural or administrative” may include incident response processes, management oversight, security awareness and training. Security controls classified as “technical or logical” may include user authentication and logical access controls, intrusion detection systems, encryption measures, antivirus software, quarantine processes, and firewalls. Security controls classified as “legal and regulatory” or “compliance controls” may include privacy laws, policies (e.g., hiring, termination, equipment usage, facility access, auditing, training), business continuity plans or response plans, and clauses.

Computing system 161A may act on shared data 132 in other ways. For example, computing system 161A may identify the severity ratings of specific vulnerabilities identified by notification 133 to such ratings warrant increasing the severity of a given vulnerability in vulnerability tracking systems. Computing system 161A may add additional signals to watch for to any security information and event management system or other security monitoring tools to cover the attack vectors and methods used in the attack. Computing system 161A may also historically compare the attack fingerprint with existing logs and evaluate whether the attack pattern identified by notification 133 existed within the records maintained by entity 150A and was not previously recognized as an attack. Similar operations may be performed by each of computing system 161B through 161N.

FIG. 1B is a conceptual diagram illustrating a process that may be employed by one or more of computing systems 161 for processing shared data 132 from data warehouse 199, in accordance with one or more aspects of this disclosure. In FIG. 1B, pattern analytics engine 141 may receive shared data 132 from computing system 181, representing data collected from each of entities 150 by corresponding computing systems 161. Pattern analytics engine 141 may use shared data 132 to generate security intelligence 142, which may involve analytics aggregation, near-real time entity risk/dynamic context, behavioral patterns, scenario modeling, attack chain mapping, asset inventory assessment, and vulnerability measurement. Based on this intelligence, pattern analytics engine 141 may correlate information, such as logs, across all assets and detection capabilities to identify early indicators of risk (IOR) 143. Pattern analytics engine 141 may apply control module 147, based on the early indicators of risk 143, to automate control deployment and/or strengthening of existing controls. Such control deployment and/or strengthening may be applied consistent with management information 145 associated with the relevant entity 150. Management information 145 may include policy, posture, and playbook management information applicable to the relevant entity 150 and/or network infrastructure 151.

Techniques described herein may therefore provide certain technical advantages. For example, techniques described herein may enable and/or facilitate the sharing of industry insights, leverage artificial intelligence and/or machine learning-based attack pattern recognition techniques, and enable automated response deployment. By implementing the described collaborative approach to cybersecurity measures, adverse effects of cyberattacks may be reduced. Such reductions may be the result of faster identification of such attacks through recognition of attack fingerprints through information sharing with industry peers, and accelerating response time through automation. Further, effective sharing of data may result in a positive feedback loop that motivates all entities in a given industry to participate in sharing information.

In addition, techniques described herein applied to a given industry may improve the industry as a whole, if entities in the industry successfully share data for their common benefit. For industries critical to society, such benefits and strengthening may extend to society itself.

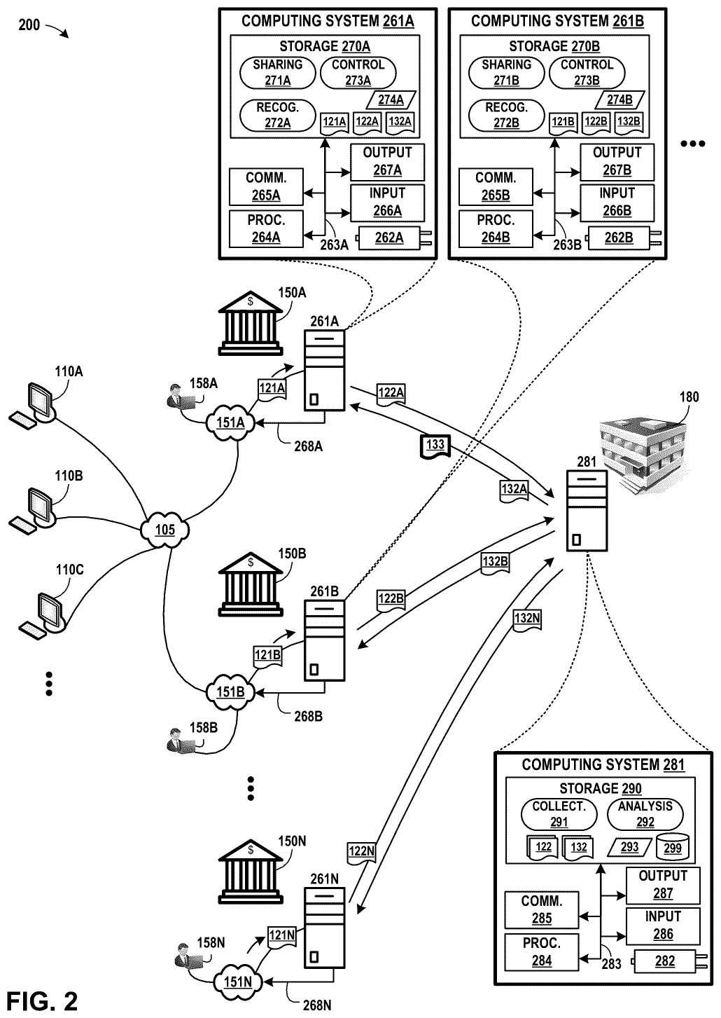

FIG. 2 is a block diagram illustrating an example system in which multiple entities contribute data to data warehouse to enable enhanced detection and/or response to cyberattacks, in accordance with one or more aspects of the present disclosure. FIG. 2 may be described as an example or alternative implementation of system 100 of FIG. 1A. In the example of FIG. 2, system 200 includes many of the same elements described in FIG. 1A, and elements illustrated in FIG. 2 may correspond to earlier-illustrated elements that are identified by like-numbered reference numerals. In general, such like-numbered elements may represent previously-described elements in a manner consistent with prior descriptions, although in some examples, such elements may be implemented differently or involve alternative implementations with more, fewer, and/or different capabilities and/or attributes.

Computing system 281, illustrated in FIG. 2, may correspond to computing system 181 of FIG. 1A. Similarly, computing systems 261A through 261N (collectively, “computing systems 261”) may correspond to computing systems 161A through 161N, illustrated in FIG. 1A. These devices, systems, and/or components may be implemented in a manner consistent with the description of the corresponding system provided in connection with FIG. 1A, although in some examples such systems may involve alternative implementations with more, fewer, and/or different capabilities. For ease of illustration, only computing systems 261A, 261B, and 281 are illustrated in detail in FIG. 2. However, any number of computing systems 261 and 281 may be included within system 200, and techniques described herein may apply to a system having any number of computing systems 261 or computing systems 281.

Each of computing system 281 and computing systems 261A through 261N may be implemented as any suitable computing system, which may encompass one or more server computers, workstations, mainframes, appliances, cloud computing systems, and/or other computing systems that may be capable of performing operations and/or functions described in accordance with one or more aspects of the present disclosure. In some examples, any of computing systems 281 and 261A through 261N may represent a cloud computing system, server farm, and/or server cluster (or portion thereof) that provides services to client devices and other devices or systems. In other examples, such systems may represent or be implemented through one or more virtualized compute instances (e.g., virtual machines, containers) of a data center, cloud computing system, server farm, and/or server cluster.

In the example of FIG. 2, computing system 281 may include power source 282, one or more processors 284, one or more communication units 285, one or more input devices 286, one or more output devices 287, and one or more storage devices 290. Storage devices 290 may include collection module 291, analysis module 295, and data store 299.

Power source 282 may provide power to one or more components of computing system 281. Power source 282 may receive power from the primary alternating current (AC) power supply in a building, home, or other location. In other examples, power source 282 may be a battery or a device that supplies direct current (DC). In still further examples, computing system 281 and/or power source 282 may receive power from another source. One or more of the devices or components illustrated within computing system 281 may be connected to power source 282, and/or may receive power from power source 282. Power source 282 may have intelligent power management or consumption capabilities, and such features may be controlled, accessed, or adjusted by one or more modules of computing system 281 and/or by one or more processors 284 to intelligently consume, allocate, supply, or otherwise manage power.

One or more processors 284 of computing system 281 may implement functionality and/or execute instructions associated with computing system 281 or associated with one or more modules illustrated herein and/or described below. One or more processors 284 may be, may be part of, and/or may include processing circuitry that performs operations in accordance with one or more aspects of the present disclosure. Examples of processors 284 include microprocessors, application processors, display controllers, auxiliary processors, one or more sensor hubs, and any other hardware configured to function as a processor, a processing unit, or a processing device. Computing system 281 may use one or more processors 284 to perform operations in accordance with one or more aspects of the present disclosure using software, hardware, firmware, or a mixture of hardware, software, and firmware residing in and/or executing at computing system 281.

One or more communication units 285 of computing system 281 may communicate with devices external to computing system 281 by transmitting and/or receiving data, and may operate, in some respects, as both an input device and an output device. In some examples, communication unit 285 may communicate with other devices over a network. In other examples, communication units 285 may send and/or receive radio signals on a radio network such as a cellular radio network. In other examples, communication units 285 of computing system 281 may transmit and/or receive satellite signals on a satellite network such as a Global Positioning System (GPS) network.

One or more input devices 286 may represent any input devices of computing system 281 not otherwise separately described herein. One or more input devices 286 may generate, receive, and/or process input from any type of device capable of detecting input from a human or machine. For example, one or more input devices 286 may generate, receive, and/or process input in the form of electrical, physical, audio, image, and/or visual input (e.g., peripheral device, keyboard, microphone, camera).

One or more output devices 287 may represent any output devices of computing systems 281 not otherwise separately described herein. One or more output devices 287 may generate, receive, and/or process output from any type of device capable of outputting information to a human or machine. For example, one or more output devices 287 may generate, receive, and/or process output in the form of electrical and/or physical output (e.g., peripheral device, actuator).

One or more storage devices 290 within computing system 281 may store information for processing during operation of computing system 281. Storage devices 290 may store program instructions and/or data associated with one or more of the modules described in accordance with one or more aspects of this disclosure. One or more processors 284 and one or more storage devices 290 may provide an operating environment or platform for such modules, which may be implemented as software, but may in some examples include any combination of hardware, firmware, and software. One or more processors 284 may execute instructions and one or more storage devices 290 may store instructions and/or data of one or more modules. The combination of processors 284 and storage devices 290 may retrieve, store, and/or execute the instructions and/or data of one or more applications, modules, or software. Processors 284 and/or storage devices 290 may also be operably coupled to one or more other software and/or hardware components, including, but not limited to, one or more of the components of computing system 281 and/or one or more devices or systems illustrated as being connected to computing system 281.

Collection module 291 of computing system 281 may perform functions relating to receiving processed data 122 from each of computing systems 261, and storing such data within a data warehouse (e.g., which may be represented by data store 299). Collection module 291 may expose an API (application programming interface) that one or more of computing systems 261 engage to upload processed data 122. In some examples, collection module 291 may specify and/or define the form in which processed data 122 should be uploaded, and at least in that sense, computing system 281 may define or mandate the disclosure of certain attributes of processed data 122 received from computing systems 261, and/or may define or mandate the format in which such data is transmitted by each of computing systems 261.

In some examples, collection module 291 may validate and/or compensate for fraudulent data that might be uploaded by one or more of computing systems 261. For instance, if marketplace competitors are sharing data, some of the participants or entities 150 may see an advantage in including “bad” data within data 122 sent to computing system 281 for storage within a shared data warehouse. Such “bad” data might include fraudulent data, false positives, malformed data that causes errors, and/or noise that causes unnecessary workloads. An entity 150 that feeds bad data to the warehouse but receives from the warehouse useful data uploaded by its competitors will realize an advantage relative to those competitors. Accordingly, and to counter this situation, collection module 291 of computing system 281 may engage in a process to validate data received from computing systems 261. Such a process may be performed through a peer/node validation and a consensus model. Alternatively, or in addition, such a process may involve tracking bad data from participating entities 150 and applying relevance or trustworthiness scores to data from each entity 150.

Analysis module 292 of computing system 281 may perform functions relating to analysis of processed data 122 received from computing systems 261. In some examples, analysis module 292 may apply one or more models 293 to the data to determine whether the data is consistent with an attack occurring, and/or to determine indicators of compromise or other related information. In some examples, analysis module 292 may also train and/or retrain one or more machine learning models 293 to predict attributes of an attack or potential attack from processed data 122 received from computing systems 261.

Model 293 may be initially trained to identify anomalies or attack profiles found across the various inputs, which may include events, alerts, incidents, cyberthreat intelligence, logs, and/or other indicators of compromise. Model 293 may be trained by consolidating processed data 122 with historical and/or previously reported processed data 122 and previous inferred associations based on data from one or more of entities 150. As a result of such training, model 293 may produce outputs that include attack vector (e.g., a vulnerability was exploited, VPN credentials were exploited, social engineering was used), target (specific individual, account, compute resource), ranking of the attacker's preference of targets, frequency or cadence of the attack (how the attack progresses), identify of any malware used, what types of data are targeted in the attack, and/or information about the sophistication of the attack.

Data store 299 may represent any suitable data structure or storage medium for storing information related stored processed data 122 and/or shared data 132. Data store 299 may serve as a data warehouse similar to data warehouse 199 described in connection with FIG. 1A. The information stored in data store 299 may be searchable and/or categorized such that one or more modules within computing system 281 may provide an input requesting information from data store 299, and in response to the input, receive information stored within data store 299. Data store 299 may be primarily maintained by collection module 291.

In the example of FIG. 2, computing system 261A may include power source 262A, one or processors 264A, one or more communication units 265A, one or more input devices 266A, one or more output devices 267A, and one or more storage devices 270A. Storage devices 270A may include sharing module 271A, recognition module 272A, and control module 273A.

Similarly, computing system 261B may include power source 262B, one or processors 264B, one or more communication units 265B, one or more input devices 266B, one or more output devices 267B, and one or more storage devices 270B (which may include sharing module 271B, recognition module 272B, and control module 273B).

Power source 262A of computing system 261A may provide power to one or more components of computing system 261A. One or processors 264A of computing system 261A may implement functionality and/or execute instructions associated with computing system 261A or associated with one or more modules illustrated herein and/or described below. One or more communication units 265A of computing system 261A may communicate with devices external to computing system 261A by transmitting and/or receiving data over a network or otherwise. One or more input devices 266A may represent any input devices of computing system 261A not otherwise separately described herein. Input devices 266A may generate, receive, and/or process input, and output devices 267A may represent any output devices of computing system 261A. One or more storage devices 270A within computing system 261A may store program instructions and/or data associated with one or more of the modules of storage devices 270A in accordance with one or more aspects of this disclosure. Each of these components, devices, and/or modules may be implemented in a manner similar to or consistent with the description of other components or elements described herein.

Sharing module 271A may perform functions relating to collecting threat data 121A, generating processed data 122A, and outputting processed data 122A to computing system 281. In some examples, sharing module 271A may treat threat data 121A for privacy, competitive, or other issues to produce processed data 122A.

Recognition module 272A may perform functions relating to analysis of shared data 132 and/or notifications 133 received from computing system 281. In some examples, recognition module 272A may apply one or more machine learning models 274A to predict the existence of or attributes of an actual or potential attack on network infrastructure 151A.

Model 274A may be trained to identify information about attack vectors, targets, methods, and other attributes of an actual or potential attack as it may apply to the specific attack surface associated with network infrastructure 151A of entity 150A. Model 274A may be retrained with new information derived from shared data 132, which may include information about attacks directed to entities 150 other than entity 150A. By retraining model 274A in this way, model 274A may be able to identify actual or potential attacks that have not previously been specifically directed to network infrastructure 151A.

Control module 273A may perform functions relating to controlling, modifying, or otherwise interacting with network infrastructure 151A to compensate for, counter, or enhance network infrastructure 151A in response to actual or possible threats or attacks on network infrastructure 151A. In some examples, control module 273A may cause computing system 261A to output one or more control signals 268A to control or adjust operation of physical or virtual devices within network infrastructure 151A.

Certain aspects of computing systems 261 have been described above with respect to computing system 261A. Descriptions herein with respect to computing system 261A may correspondingly apply to one or more other computing systems 261. Other computing systems 261 (e.g., computing system 261B, 261N, and others, not shown) may therefore be considered to be described in a manner similar to that of computing system 261A, and may also include the same, similar, or corresponding components, devices, modules, functionality, and/or other features.

In operation, and in accordance with one or more aspects of the present disclosure, entity 150A may observe and collect threat data associated with network infrastructure 151A. For instance, in an example that can be described in the context of FIG. 2, input device 266A of computing system 261A detects input from network infrastructure 151A and outputs information about the input to sharing module 271A. Sharing module 271A determines that the input corresponds to or includes data associated with activity or operations taking place within network infrastructure 151A. In some examples, computing system 261A receives such data in response to an explicit request (e.g., a request output to network infrastructure 151A through output device 267A and/or communication unit 265A). In other examples, computing system 261A may subscribe to the data and receive occasional, periodic, or continual updates about various activity or operations taking place within network infrastructure 151A. Sharing module 271A evaluates the data and identifies and/or extracts threat data 121A, which may pertain to logs, incidents, cyberthreat intelligence information, events, alerts, and/or other indicators of compromise.

Entity 150A may modify the threat data about network infrastructure 151A to make the data suitable for sharing. For instance, continuing with the example being described in the context of FIG. 2, sharing module 271A of computing system 261A processes threat data 121A to create processed data 122A. Processed data 122A may represent threat data 121A after translating threat data 121A into a machine readable format that may be suitable for use by any of computing systems 261, computing system 281, regulatory agencies, or cyberthreat intelligence providers. Alternatively, or in addition, sharing module 271A may process threat data 121A to anonymize and/or remove certain privacy information that would be inappropriate for sharing outside of systems controlled by entity 150A and/or network infrastructure 151A. Sharing module 271A may, for example, apply standardized data anonymization mechanism (e.g., data masking or generalization) to protect sensitive partner data or personally identifiable information and thereby generate processed data 122A.

Entity 150A may communicate the threat data to a data warehouse. For instance, still continuing with the example being described in the context of FIG. 2, sharing module 271A causes communication unit 265A to output processed data 122A over a network (not specifically shown in FIG. 2) to computing system 281, which may serve as a data warehouse.

Communication unit 285 of computing system 281 detects a signal and outputs information about the input to collection module 291. Collection module 291 of computing system 281 determines that the signal includes or corresponds to processed data 122A derived from network infrastructure 151A operated by entity 150A. Collection module 291 stores processed data 122A within data store 299.

Other entities 150 may also share data with the data warehouse. For instance, again with reference to the example being described in the context of FIG. 2, computing system 261B collects, in a manner similar to that described with respect to computing system 261A, threat data 121B from network infrastructure 151B, processes threat data 121B to generate processed data 122B, and shares processed data 122B with computing system 281. Similarly, other computing systems 261 collect threat data 121, generate processed data 122, and share processed data 122 with computing system 281. In other words, and in general, computing system 261N collects threat data 121N from network infrastructure 151N, processes threat data 121N to generate processed data 122N, and shares processed data 122N with computing system 281. In each case, computing system 281 receives the corresponding processed data 122 from each of computing systems 261 and stores the processed data 122 within data store 299.

Organization 180 may evaluate the shared data. For instance, again referring to FIG. 2, analysis module 292 of computing system 281 applies model 293 to processed data 122 received from each of computing systems 261. In some examples, analysis module 292 applies model 293 to recent processed data 122 received from each of computing systems 261 so that the model is making assessments about current activity associated with network infrastructure 151 for each of entity 150. In some cases, such assessments may even occur sufficiently quickly and/or frequently so that the assessments appear to take place in near- or seemingly-near real time. Model 293 classifies the collective processed data 122 to determine whether the data shows characteristics consistent with known previous attack patterns (e.g., attack patterns that were included in data used to train model 293). Often, model 293 will determine that there is no match, suggesting that the processed data 122 does not indicate an attack occurring at network infrastructure 151 associated with any of entities 150. In some cases, however, model 293 may, with a sufficient confidence level, identify a match to a known or potential attack pattern.

Organization 180 may notify one or more entities that may be under attack. For instance, with reference to FIG. 2, model 293 of computing system 281 determines that processed data 122A received from computing system 261A matches a known attack pattern. Analysis module 292 concludes that an attack may be occurring within network infrastructure 151A associated with entity 150A. Analysis module 292 associates the attack and its characteristics with an attacker profile. Analysis module 292 causes communication unit 285 to output notification 133 to computing system 261A, which is operated by entity 150A. Notification 133 includes information about the attack, including attributes of the attack. Such attributes may include information about the attack vector, the target, severity or ranking or sophistication of the attack, frequency, data that may be vulnerable, methods of the attack, and/or other information about the attack.

Entity 150A may respond to the attack. For instance, referring to FIG. 2, communication unit 265A of computing system 261A detects input and outputs information about the input to recognition module 272A. Recognition module 272A determines that the input includes or corresponds to notification 133. Recognition module 272A further determines that notification 133 indicates that computing system 281 has determined that an attack on network infrastructure 151A may be occurring. Recognition module 272A may cause communication unit 285A to send a notification to appropriate personnel, such as by outputting one or more messages to administrator computing device 158A, which may be operated and/or monitored by an administrator of network infrastructure 151A. In some cases, since computing system 281 identified the attack based on processed data 122A, recognition module 272A (and/or an administrator) may have already been aware of the attack prior to computing system 261A receiving notification 133. Accordingly, computing system 261A (e.g., control module 273A) may have already taken steps to counter the attack. Alternatively, or in addition, and particularly if recognition module 272A had not previously recognized the attack, recognition module 272A outputs information about notification 133 to control module 273A. Control module 273A uses the information about notification 133 to counter the attack, such as by outputting one or more control signals 268A to modify operation of various aspects of network infrastructure 151A.

Organization 180 may share information about the attack on entity 150A with other entities 150. For instance, still continuing with the example being described in the context of FIG. 2, responsive to analysis module 292 concluding that an attack may be taking place at network infrastructure 151A operated by entity 150A, analysis module 292 causes communication unit 285 of computing system 281 to output a series of signals to computing systems 261. For example, communication unit 265B of computing system 261B detects a signal from computing system 281 and outputs information about the signal to recognition module 272B. Recognition module 272B determines that the signal includes shared data 132B. Recognition module 272B further determines that recognition module 272B includes information about an attack directed at one of the peers of entity 150B (i.e., another one of entities 150). Shared data 132B might not specifically identify that entity 150A is the target of the attack, but shared data 132B may include attributes and/or information about the attack, including information about events, alerts, incidents, cyberthreat information, logs, and/or other indicators of compromise associated with the attack directed to entity 150A. Other computing systems 261 also receive corresponding shared data 132 including similar or the same information. In other words, and in general, communication unit 265N of computing system 261N detects a corresponding signal from computing system 281, and recognition module 272N of computing system 261N determines that the signal includes shared data 132N, which may include information an attack directed at another one of entities 150.

Other entities 150 may evaluate information about the peer attack experienced by entity 150A. For example, recognition module 272B of computing system 261B outputs information about shared data 132B to control module 273B. Control module 273B applies model 274B to shared data 132B, which may include information about events, alerts, incidents, cyberthreat information, logs, indicators of compromise, and/or other attributes of the attack. Model 274B may, as a result, identify and/or differentiate the characteristics or fingerprints of a possible attack, and may identify an associated attacker profile. Model 274B may also produce outputs including but not limited to an attack vector (e.g., a vulnerability was exploited, VPN credentials were exploited, social engineering was used), a target (i.e., specific individual, account, compute resource, etc.), a ranking of the attacker's preference of targets, a frequency and/or cadence associated with how the attack progresses, any type of malware used and/or payload, the type of data taken or extracted, the sophistication of the attack, methods used in attack, and/or other information.

Other entities 150 may take actions to prevent an attack similar to that experienced by entity 150A. For instance, again with reference to FIG. 2, control module 273B of computing system 261B may initiate, based on the produced outputs, any number of appropriate actions. Control module 273B of computing system 261B may carry out each of such actions by causing communication unit 265B to output a control signal 268B to network infrastructure 151B to cause modifications to network infrastructure 151B and/or to cause one or more elements within network infrastructure 151B to perform an action.

Each of the possible actions that could be performed (as described below) may be taken by control module 273B of computing system 261B (e.g., through control signal 268B) or by other systems within network infrastructure 151B. Actions taken may include identifying relevant controls or security controls that exist within network infrastructure 151B, evaluating such controls, strengthening such controls, deploying additional controls (e.g., on a just-in-time basis). In some cases, such controls may be deployed automatically to mitigate the risk of the newly identified potential cyberattack. Actions taken can also include dynamically increasing severity levels of vulnerability of remediation systems for identified attack threats. Other actions may involve engaging or executing of other control activities to strengthen existing security controls (e.g., web application firewall blocking). Other actions may involve performing additional monitoring for known attack fingerprints via security information and event management or other monitoring tools. Still other actions may include comparing known attack parameters against internal input data sources to identify previously unrecognized attacks which may be in progress. If fingerprints or other indicators match a known attack or attacker, control module 273B may take action through distraction and/or evasive tactics. Such tactics may involve initiating ephemeral honeypots to enable enhanced forensics, time to engage law enforcement, root cause identification of the attacker, and for collecting information that can be stored and/or potentially shared as processed data 122.

Modules illustrated in FIG. 2 (e.g., sharing modules 271, recognition modules 272, control modules 273, collection module 291, and analysis module 292) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

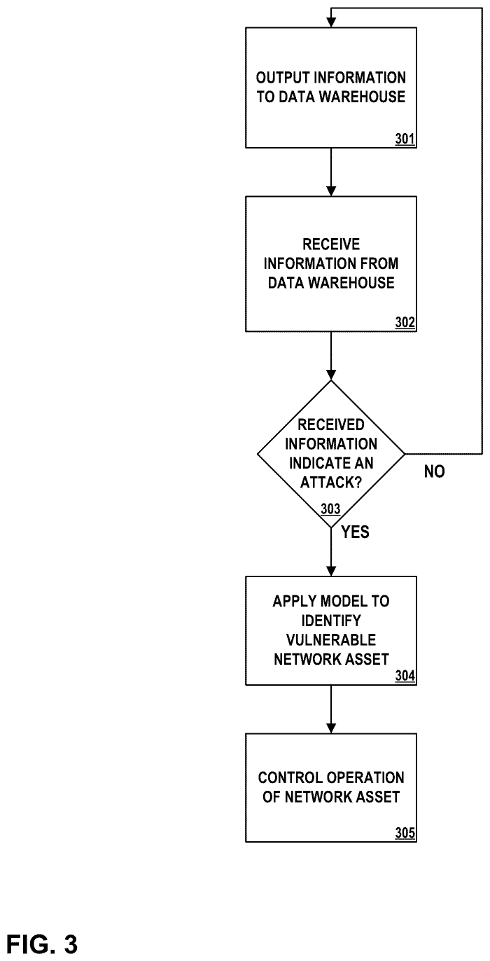

FIG. 3 is a flow diagram illustrating operations performed by an example computing system 161 in accordance with one or more aspects of the present disclosure. FIG. 3 is described below within the context of computing system computing systems 161 of FIG. 1A. In other examples, operations described in FIG. 3 may be performed by one or more other components, modules, systems, or devices. Further, in other examples, operations described in connection with FIG. 3 may be merged, performed in a difference sequence, omitted, or may encompass additional operations not specifically illustrated or described.

In the process illustrated in FIG. 3, and in accordance with one or more aspects of the present disclosure, one or more computing systems 161 may output information to a data warehouse (301). For example, with reference to FIG. 1A, each of computing systems 161 collect threat data 121 about operations and/or activity performed within each of network infrastructures 151. Each of computing systems 161 then process threat data 121 to generate processed data 122, and share processed data 122 with organization 180 by outputting processed data 122 to computing system 181.

Computing systems 161 may receive information from the data warehouse (302). For example, in FIG. 1A, computing system 181 receives processed data 122 from each of computing systems 161. Computing system 181 correlates the data received from each of computing systems 161, and packages the data as shared data 132, which may be in a format that can be ingested and processed by each of computing systems 161. In some examples, computing system 181 may anonymize processed data 122 received from each of computing systems 161 to ensure that no entity 150 can be identified from shared data 132. Also, in some examples, computing system 181 may output different versions of shared data 132 to each of computing system 161. For example, computing system 181 may output shared data 132A to computing system 161A, but may output shared data 132B to computing system 161B. The differences between shared data 132A and 132B may pertain to attributes of entities 150A and 150B, network infrastructures 151A and 151B (e.g., differing attack surfaces), and/or the frequency of nature of the sharing that each of entities 150A and 150B engages in information sharing with organization 180. Computing system 181 outputs shared data 132 to each of computing systems 161.

One or more of computing systems 161 may determine whether the received information indicates an attack on another entity (303). For example, computing system 161A may receive shared data 132A from computing system 181. Computing system 161A evaluates shared data 132A to determine whether it includes information about an attack currently or recently taking place within the network infrastructure 151 associated with another entity 150 (e.g., network infrastructure 151B operated by entity 150B). In some examples, computing system 161A may separately receive notification 133, providing specific information about a current or recent attack directed at another entity 150. In other examples, computing system 161A may receive notification 133 included within shared data 132A.

Computing system 161A may apply a model to identify a vulnerable network asset (304). For example, computing system 161A may apply model 274A to shared data 132A to determine whether shared data 132A indicates an attack is currently occurring (or has recently occurred) across any of network infrastructures 151 operated by entities 150. If shared data 132A indicates an attack, model 274A may alternatively, or in addition, identify an asset within network infrastructure 151A that may be vulnerable to the attack. In some examples, model 274A may be trained to determine, based on shared data 132, both whether an attack has occurred and the identity of one or more network assets that may be vulnerable to the attack.

Computing system 161A may control operation of the one or more identified network assets (305). For example, computing system 161A may output a signal to modify the operation of network infrastructure 151A to bolster the attack resilience of the identified vulnerable network assets included within network infrastructure 151A. In some cases, computing system 161A may output a signal to hardware within network infrastructure 151A to automatically deploy a new security control intended to prevent negative effects of an attack on network infrastructure 151A. In other examples, computing system 161A may output a signal to automatically modify or update the operation of an existing security control, which may also prevent any negative effects of an attack. Computing system 161A may automatically output signals to perform other operations that may bolster the resilience of network infrastructure 151A, such as modifying configurations on a web application firewall, modifying routing patterns of network traffic, disabling virtual and/or physical compute nodes, or other operations.

In some examples, however, where computing system 161A determines that shared data 132A does not indicate a current or recent attack involving another entity 150, computing system 161A might not necessarily immediately act on shared data 132A, but may store shared data 132A for further analysis. Such further analysis may involve training or retraining model 274A using shared data 132A (e.g., providing training data that indicates “normal” network operations).

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The disclosures of all publications, patents, and patent applications referred to herein are hereby incorporated by reference. To the extent that any material that is incorporated by reference conflicts with the present disclosure, the present disclosure shall control.

For ease of illustration, only a limited number of devices (e.g., client devices 110, administrator computing devices 158, computing systems 161, computing system 181, computing systems 261, computing system 281, as well as others) are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including, to the extent appropriate, a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method comprising:
outputting, by a computing system operated by a first entity and to a data warehouse, information about activity within a first network operated by the first entity;
receiving, by the computing system and from the data warehouse, information about attributes of a peer attack directed to a second network operated by a second entity, wherein the first entity and the second entity are distinct organizations;
applying, by the computing system, a model to identify a network asset included within the first network that is vulnerable to an attack having the attributes of the peer attack; and
outputting, by the computing system and to the network asset, a control signal to modify the operation of the network asset.

2. The method of claim 1, wherein outputting the control signal includes:
outputting the control signal to protect the first network against an attack having the attributes of the peer attack.

3. The method of claim 2, wherein outputting the control signal further includes:
deploying a new security control within the first network.

4. The method of claim 2, wherein outputting the control signal further includes:
modifying the operation of an existing security control within the first network.

5. The method of claim 1, further comprising:
retraining, by the computing system, the model to recognize the attributes of the peer attack.

6. The method of claim 1, wherein outputting information about activity within the first network includes:
regularly outputting information about activity within the first network.

7. The method of claim 1, wherein outputting information about activity within the first network includes:
outputting information about an attack occurring within the first network.

8. The method of claim 1, wherein outputting information about activity within the first network includes:
outputting processed information, wherein the processed information includes data that has been modified to remove references to the first entity and to remove privacy information associated with any customers of the first entity.

9. The method of claim 1, wherein the first entity and the second entity are marketplace competitors, and wherein receiving information about attributes of a peer attack includes:
receiving information that has been processed to remove references to the second entity and to remove privacy data associated with any customers of the second entity.

10. The method of claim 1, further comprising:
receiving, by the computing system and from the data warehouse, information about normal activity taking place at a third network operated by a third entity, wherein the first entity and the third entity are marketplace competitors.

11. A computing system operated by a first entity and comprising processing circuitry and a storage device, wherein the processing circuitry has access to the storage device and is configured to:
output, to a data warehouse, information about activity within a first network operated by the first entity;
receive, from the data warehouse, information about attributes of a peer attack directed to a second network operated by a second entity, wherein the first entity and the second entity are separate organizations;
apply a model to identify a network asset included within the first network that is vulnerable to an attack having the attributes of the peer attack; and
output, to the network asset, a control signal to modify the operation of the network asset.

12. The computing system of claim 11, wherein to output the control signal, the processing circuitry is further configured to:
output the control signal to protect the first network against an attack having the attributes of the peer attack.

13. The computing system of claim 12, wherein to output the control signal, the processing circuitry is further configured to:
deploy a new security control within the first network.

14. The computing system of claim 12, wherein to output the control signal, the processing circuitry is further configured to:
modify the operation of an existing security control within the first network.

15. The computing system of claim 11, wherein the processing circuitry is further configured to:
retrain the model to recognize the attributes of the peer attack.

16. The computing system of claim 11, wherein to output information about activity within the first network, the processing circuitry is further configured to:
regularly output information about activity within the first network.

17. The computing system of claim 11, wherein to output information about activity within the first network, the processing circuitry is further configured to:
output information about an attack occurring within the first network.

18. The computing system of claim 11, wherein to output information about activity within the first network, the processing circuitry is further configured to:
output processed information, wherein the processed information includes data that has been modified to remove references to the first entity and to remove privacy information associated with any customers of the first entity.

19. The computing system of claim 11, wherein the processing circuitry is further configured to:
receive, from the data warehouse, information about normal activity taking place at a third network operated by a third entity, wherein each of the first entity, the second entity, and the third entity are marketplace competitors.

20. A non-transitory computer-readable medium comprising instructions that, when executed, configure processing circuitry of a computing system to:
output, to a data warehouse, information about activity within a first network operated by the first entity;
receive, from the data warehouse, information about attributes of a peer attack directed to a second network operated by a second entity, wherein the first entity and the second entity are different organizations;
apply a model to identify a network asset included within the first network that is vulnerable to an attack having the attributes of the peer attack; and
output, to the network asset, a control signal to modify the operation of the network asset.
